(19) United States
(12) Patent Application Publication
(10) Pub. No.: US 2016/0012295 A1
(43) Pub. Date: Jan. 14, 2016

(54) IMAGE PROCESSOR, METHOD AND PROGRAM

(71) Applicant: Kabushiki Kaisha Toshiba, Tokyo (JP)

(72) Inventors: Kazunori Imoto, Kawasaki Kanagawa (JP); Shihomi Takahashi, Yokohama Kanagawa (JP); Isao Mihara, Tokyo (JP)

(21) Appl. No.: 14/792,339

(22) Filed: Jul. 6, 2015

(30) Foreign Application Priority Data
Jul. 8, 2014 (JP) 2014-140481

(51) Int. Cl. G06K 9/00; G06T 7/00; G06K 9/34

(52) U.S. Cl. CPC G06K 9/00751; G06K 9/344; G06T 7/0097; G06K 2209/01; G06T 2207/10016

(57) ABSTRACT

According to one embodiment, an image processor includes a writing amount detector and an end timing detector. The writing amount detector detects a writing amount in an image. The end timing detector detects an end timing of writing based on the writing amount detected by the writing amount detector.

### CROSS-REFERENCE TO RELATED APPLICATIONS

This application is based upon and claims the benefit of priority from Japanese Patent Application No. 2014-140481, filed Jul. 8, 2014, the entire contents of which are incorporated herein by reference.

### FIELD

Embodiments described herein relate generally to an image processor, a method and a program.

### BACKGROUND

Checking the contents of the whole of a moving image or a set of still images and efficiently accessing an image of a topic to watch are required. For example, in the educational field, the technology to divide a lecture video made by shooting a lecture by a video camera where the lecturer uses a slide projector into a plurality of topics in accordance with major changes of the contents of slides, to generate topic images that show the content of each topic and to show a list of the topic images is well known. A user can see the topic images and thereby easily find a topic to watch.

Since the conventional technology is based on the premise that slides showing the lesson contents are projected, video can be divided into topics in accordance with major changes of the contents of the slides. However, the conventional technology has a problem that images of, for example, a blackboard, where writing and erasing are repeated and contents are momentarily changed cannot be divided into topics. The problem may arise not only in the educational field, but also in watching video (a moving image or a set of still images) undivided into chapters. The problem may also arise in a moving image made by shooting a blackboard by a video camera that describes a progress situation of public engineering works.

### BRIEF DESCRIPTION OF THE DRAWINGS

FIG. 1 is an exemplary block diagram showing a system configuration of an image processor of an embodiment.

FIG. 2 is an exemplary block diagram showing the operation of an automatic chaptering application.

FIGS. 3A, 3B and 3C show an example of the operation of a background and writing block extraction module 54.

FIGS. 4A and 4B show an example of the operation of a structuring processor 58.

FIGS. 5A, 5B and 5C show a changing state of a blackboard to illustrate an example of the operation of an end computation module 56.

FIGS. 6A, 6B and 6C are exemplary graphs showing a time change of a writing amount per area to illustrate an example of the operation of the end computation module 56.

FIG. 7 is an illustration showing an example of the operation of a chapter image generation module 60.

FIGS. 8A and 8B show an example of the display of an LCD 42.

FIG. 9 is an illustration showing another example of the display of the LCD 42.

FIG. 10 is an illustration showing another example of the operation of the chapter image generation module 60.

FIG. 11 is an exemplary illustration showing a configuration of a second embodiment that executes the automatic chaptering application in a server.

### DETAILED DESCRIPTION

Various embodiments will be described hereinafter with reference to the accompanying drawings.

In general, according to one embodiment, an image processor includes a writing amount detector and an end timing detector. The writing amount detector detects a writing amount in an image. The end timing detector detects an end timing of writing based on the writing amount detected by the writing amount detector.

The embodiments of the image processor can be implemented by various devices such as desktop or laptop general-purpose computers, portable general-purpose computers, other portable information devices, information devices including an imaging device, smart phones and other information processors. In the description below, a laptop general-purpose computer is described as an example. The laptop general-purpose computer (not shown) is constituted by a computer body and a display unit attached to the body by a hinge so as to be openable and closable. The computer body has a thin box-shaped housing. A keyboard, a power button, a touchpad, a speaker, etc., are arranged on the upper surface of the housing. An LCD panel is incorporated into the display unit.

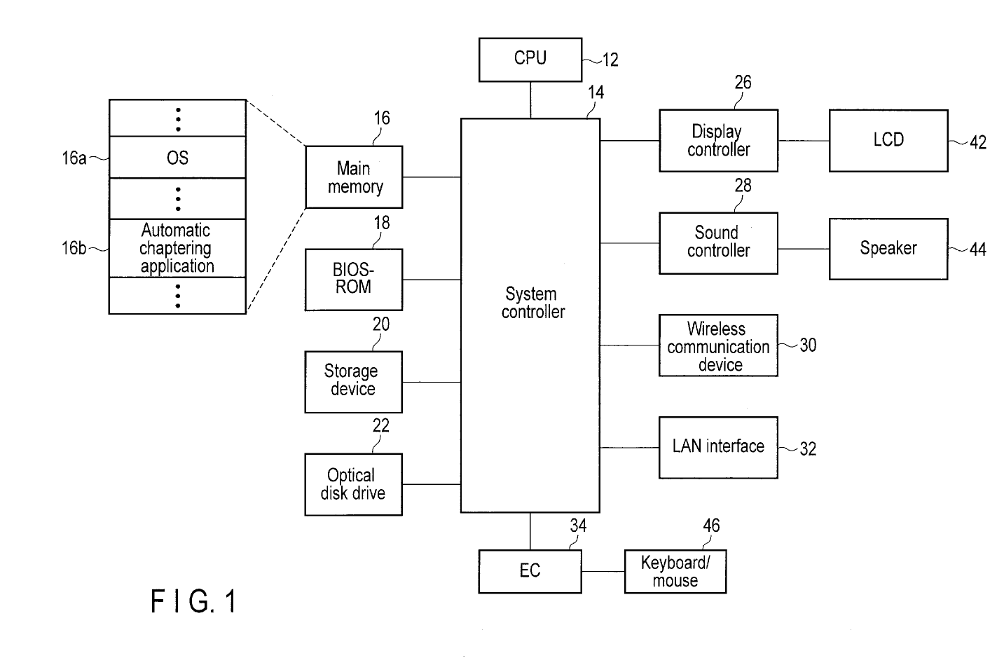

FIG. 1 is a block diagram showing a system configuration of the laptop general-purpose computer. The general-purpose computer includes a CPU 12, a system controller 14, a main memory 16, a BIOS-ROM 18, a storage device (HDD, SSD, etc.) 20, an optical disk drive (DVD drive, etc.) 22, a display controller 26, a sound controller 28, a wireless communication device 30, a LAN interface 32, an embedded controller 34, etc.

The CPU 12 is a processor that controls operations of various components mounted on the general-purpose computer. The CPU 12 executes various types of software loaded from the nonvolatile storage device 20 to the main memory 16. The software includes an operating system (OS) 16a, an automatic chaptering application program 16b, etc. The automatic chaptering application program 16b analyzes video content, detects topic end timings and divides the video content into a plurality of chapters according to topics.

The CPU 12 also executes a basic input/output system (BIOS) stored in the BIOS-ROM 18. The BIOS is a program for hardware control.

The system controller 14 is a device that connects the CPU 12 with various components. The system controller 14 includes a memory controller that executes access control of the main memory 16. The main memory 16, the BIOS-ROM 18, the storage device 20, the optical disk drive 22, the display controller 26, the sound controller 28, the wireless communication device 30, the embedded controller 34, etc., are connected to the system controller 14.

The display controller 26 controls an LCD 42. The display controller 26 transmits a display signal to the LCD 42 under the control of the CPU 12. The LCD 42 displays a screen image based on the display signal. The sound controller 28 is a controller that processes an audio signal. The sound controller 28 controls audio output of the speaker 44. The wireless communication device 30 is a device configured to execute wireless communication such as wireless LAN conforming to the IEEE 802.11g standard or 3G mobile communication or short-range wireless communication such as near-field communication (NFC) to be connected to a network. The LAN interface 32 is configured to execute, for example, wire communication conforming to the IEEE 802.3 standard to be connected to the network. The embedded controller 34 is a one-chip microcomputer including a controller for power management. The embedded controller 34 has a function of powering on and off the general-purpose computer in accordance with power button operation by a user (not shown). A keyboard/mouse 46 is connected to the embedded controller 34.

Next, the automatic chaptering application program 16b is schematically described. The automatic chaptering application program 16b is often used together with a video viewing application to access desired information from video of, for example, a lecture where the lecturer projects slides of presentation or a lesson where the teacher writes on a blackboard or a whiteboard. The blackboard and the whiteboard are hereinafter collectively called blackboards. The video to be processed is not limited to a moving image, but may be a set of still images. In addition, the video is not limited to educational video, but may be video of a meeting or arrangement using a blackboard. When video of a lecture or lesson undivided into chapters is viewed, the automatic chaptering application program 16b can compute an end timing of each topic, divide the video into a plurality of topics, i.e., chapters to find the beginning of each chapter and display a snapshot near the topic end timing as a thumbnail representative of the topic. Therefore, the contents of the entire video can be efficiently checked.

Conventionally, video of a scene where a slide that displays the same contents for a certain time is projected can be divided into chapters in accordance with changes of the slide contents. However, video of, for example, a blackboard on which writing and erasing are repeated and contents are momentarily changed cannot be divided into chapters since topic end timings cannot be detected. In contrast, the automatic chaptering application program 16b extracts writing blocks from video, computes a writing amount of the blocks and computes, based on the writing amount, an end timing (i.e., a start/end point of a topic) showing that writing of a topic is temporarily stopped.

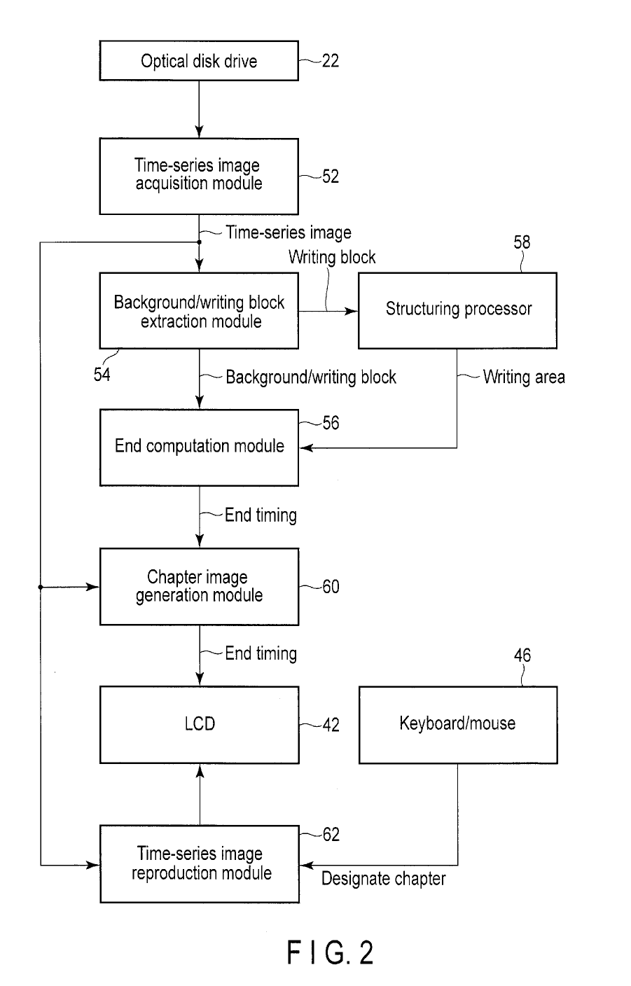

FIG. 2 shows a functional block of the automatic chaptering application program 16b. First, video from a video source is input to a time-series image acquisition module 52. The video source may be an output signal of the optical disk drive 22 reproducing an educational DVD including, for example, a lesson or lecture, or an educational material downloaded from the Internet and temporarily stored in the storage device 20. The video source may also be an output signal from a video camera that captures a lesson, lecture or the like.

The time-series image acquisition module 52 acquires time-series images to be subjected to automatic chaptering processing from the input signal. The time-series images to be processed are time-series images obtained by capturing a scene where a lecturer delivering a lecture or a chair presiding at a meeting writes characters on a blackboard or whiteboard. If the input signal is encoded in the MPEG format, the signal is decoded in the time-series image acquisition module 52 and the original time-series images are thereby extracted. Each frame image or each field image of the time-series images is accompanied by time data. The time data is used in a background/writing block extraction module 54, a structuring processor 58 and a chapter image generation module 60. In the background/writing block extraction module 54 and the structuring processor 58, writing blocks and writing areas to be described later are computed based on the time data. In the chapter image generation module 60, an image having time data of the end timing may be determined as a chapter image.

The time-series images to be processed are input to the background/writing block extraction module 54. The extraction module 54 analyzes the time-series images, extracts a background in each frame and extracts writing blocks from the background. The background is the largest area (in particular, a blackboard) on which the lecturer can write characters, and is extracted by finding the largest area having pixels of a color unchanged for a long time. In the time-series images, a frame is not necessarily filled with the blackboard, but objects other than the blackboard (for example, the wall of a room) may also be seen.

A writing block is constituted by positional data and time data indicative of a position and a time, respectively, at which an area different from the background is expressed by a writing action. In other words, a start time and an end time of a period when a pixel value is different from the background are described per area. The positional data (area) may be expressed in a unit of pixel or by an area of a certain size including pixels different from the background.

Considering a processing load of the blocks in the subsequent stage, the positional data may be expressed in a unit of character, word or line, not pixel. For example, the writing blocks are expressed as follows.

(s1,xb1,yb1)−(e1,xb1,yb1)

(s2,xb2,yb1)−(e2,xb2,yb1)

. . .

where s is a start time, e is an end time and xb and yb are a set of coordinates in the area. The above example shows that the area (xb1, yb1) has a pixel value different from the background from time s1 to time e1 and the area (xb2, yb1) has a pixel value different from the background from time s2 to time e2.

If writing blocks are detected, a time-series locus of a writing action and a writing image series at a certain time can be extracted.

If a teacher is seen in the video, writing blocks must be distinguished from the teacher since the teacher also includes pixels different from the background. Once writing blocks are detected, the positions of the blocks do not change until erased. In contrast, the teacher is moving and thus the position of the teacher changes over time. Based on the difference, the extraction module 54 distinguishes between the writing blocks and the teacher.

The background and the writing blocks extracted in each frame are input to the end computation module 56. The writing blocks are also input to the structuring processor 58. The structuring processor 58 integrates the writing blocks input from the extraction module 54 into writing areas based on the unity of time and space, and outputs the writing areas to the end computation module 56. The unity of time indicates a set of temporally-consecutive writing blocks, and can be expressed as a significant unit. The unity of space indicates a set of writing blocks whose writing pixels are adjacent to each other, and can also be expressed as a significant unit similarly to the unity of time. For example, the structuring processor 58 may integrate a plurality of writing blocks into writing areas based on writing directions. The structuring processing is executed because the principle of end computation is different for the case of writing about a topic using the entire blackboard and the case of dividing the blackboard into several areas and writing about a plurality of topics in these areas, respectively.

The end computation module 56 computes a writing amount in the time-series images based on the background and the writing blocks input from the background/writing block extraction module 54 and/or the writing areas input from the structuring processor 58, and computes, based on the writing amount, an end timing showing that writing of a topic is temporarily stopped. Whether the end computation module 56 uses the background and the writing blocks or the writing areas should preferably be determined depending on the type of time-series images to be processed. The type of images relates to whether the blackboard is used in whole or per area as described above. If the type is preliminarily known, the switching may be performed by the user or automatically performed by including type information as attribute information of the contents. If the type is unknown, the writing areas are considered to be used. However, not only either the background and the writing blocks or the writing areas, but also both of them may be used.

The writing amount can be computed as a ratio of writing blocks to a background and/or a ratio of writing blocks to a writing area obtained by integrating the writing blocks. General methods of writing on the blackboard include a method using the entire blackboard and a method dividing the blackboard in half. In the former method, when contents are written to fill the blackboard, all the written contents are erased and then new contents are written. In the latter method, the following process is repeated. When contents are written to fill the blackboard divided in half, the contents in the left half is first erased and new contents are written to fill the left half, and then the contents in the right half is erased and new contents are written to fill the right half. The writing amount is often computed correctly by the ratio of writing blocks to the background in the former method, and by the ratio of writing blocks to a writing area in the latter method.

The writing amount is increased as the teacher writes on the blackboard. When the blackboard has little or no space to write, the writing space is often newly secured by erasing all or a part of the written contents. Therefore, the writing amount is increased over time, but if there is little or no writing space and the existing writing blocks are erased, the writing amount is temporarily reduced. The increasing rate of the writing amount decreases as the writing space becomes smaller. If the writing space runs out, the writing amount does not increase and is saturated. After that, if the existing writing blocks are erased, the writing amount decreases. Therefore, the end computation module 56 computes at least one of a timing when the writing amount is maximum, a timing when the writing amount reaches a predetermined value (for example, 80%), and a timing when the writing amount is substantially saturated (i.e., when the change rate becomes lower than a threshold value) as an end timing. The basis for computation should preferably be determined depending on the type of time-series images to be processed. The type of images is determined based on whether the contents are frequently and partly erased and written or written by using the entire blackboard and infrequently erased, etc. If the type is preliminary known, the switching may be performed by the user or automatically performed by including type information as attribute information of the contents.

The output of the end computation module 56 and the time-series images acquired in the time-series image acquisition module 52 are supplied to the chapter image generation module 60. The chapter image generation module 60 divides the time-series images into a plurality of chapters based on the end timings. The chapter image generation module 60 generates a chapter image of each chapter and displays the chapter images on the LCD 42 for selection of the beginning of the time-series images. The chapter image is a representative image that expresses the contents of the chapter. For example, an image including writing blocks and writing areas used for computing the end timing may be determined as a chapter image since this image has the largest amount of information. Instead, an image including a first set of writing blocks in which information such as a title or theme is expressed without interruption after the previous end timing may be determined as a chapter image.

The LCD 42 can display a plurality of chapter images. When any one of the chapter images is selected by the keyboard/mouse 46, the time-series data is reproduced from a position corresponding to the selected chapter image. To implement such reproduction, the time-series images are supplied to a time-series image reproduction module 62 and chapter designation data indicative of the selected chapter is input from the keyboard/mouse 46 to the time-series image reproduction module 62. Since the end timing is a timing of the end of a lecture on a topic, if the reproduction is started from the end timing, the lecture is immediately shifted to the next topic. Therefore, the reproduction may be started from an end timing immediately preceding the selected end timing.

As described above, start/end points of topics can be computed in images of, for example, a blackboard where the contents are momentarily changed by computing end timings that are start/end points of the topics based on writing blocks extracted from images of the blackboard. Therefore, the time-series images can be divided into chapters at the end timings, the whole of the time-series images can be understood in a short time by viewing representative images of the chapters, and images of a desired topic can be immediately reproduced.

The above is a basic configuration of the present embodiment, which will be hereinafter described in detail with examples.

### EXAMPLE 1

### Basic Example (Chapter Division) Constituted by Time-Series Image Acquisition Module 52, Background/Writing block Extraction Module 52, Structuring Processor 58 and End Computation Module 56

In Example 1, writing blocks are extracted from a moving image of a lecture using a blackboard, an end timing showing that writing of a topic is temporarily stopped is computed based on the writing blocks, and the moving image is divided into chapters according to the end timings.

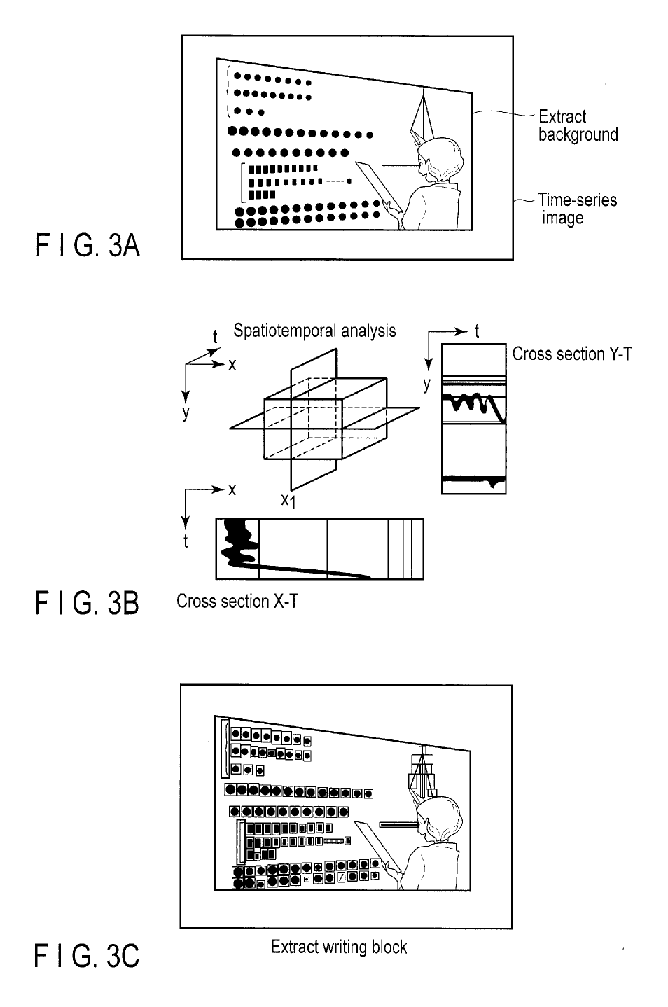

The background/writing block extraction module 54 analyzes images input from the time-series image acquisition module 52 and extracts a background and writing blocks. FIGS. 3A, 3B and 3C show an example of the operation of the background/writing block extraction module 54. As shown in FIG. 3A, a background (blackboard) having pixels of a color unchanged for a long time is extracted from the time-series images including areas other than the blackboard.

The background includes not only the writing blocks expressed by writing actions, but also an occlusion block where the writing blocks and the background are hidden behind the writer. A spatiotemporal analysis is one of the ways to distinguish between the writing blocks and the occlusion block. On the assumption that a field of view of an imaging camera is fixed, the position of the writer causing the occlusion moves over time, but the writing blocks expressed by the writing actions do not move until erased. Focusing on this point, images of the background are spatiotemporally analyzed over a certain time as shown in FIG. 3B. In the cross sections X-T and Y-T of the background images, the positions of the writing blocks do not change regardless of elapsed time. Therefore, differences between the background and the writing blocks are expressed as edges in the direction of the time axis t. The edges are constant in X positions and Y positions. In contrast, since the writer moves over time, X and Y positions of a difference between the background and the occlusion block also move. Therefore, the difference is not expressed as an edge. The writing blocks of the images can be extracted as shown in FIG. 3C by reconstructing the edges in the cross sections X-T and Y-T to the positions of X- and Y-coordinates in each time. In the example of FIG. 3A, a thickness of each edge expressed in the cross sections X-T and Y-T is not limited and even a fine edge is expressed as an edge. Therefore, the writing blocks are extracted in a unit of character or a unit of element constituting a character. Furthermore, larger blocks, for example, in a unit of line, can be extracted by temporally tracking the appearance positions of the writing blocks reconstructed to the positions of X- and Y-coordinates and integrating writing blocks having the same continuous writing direction.

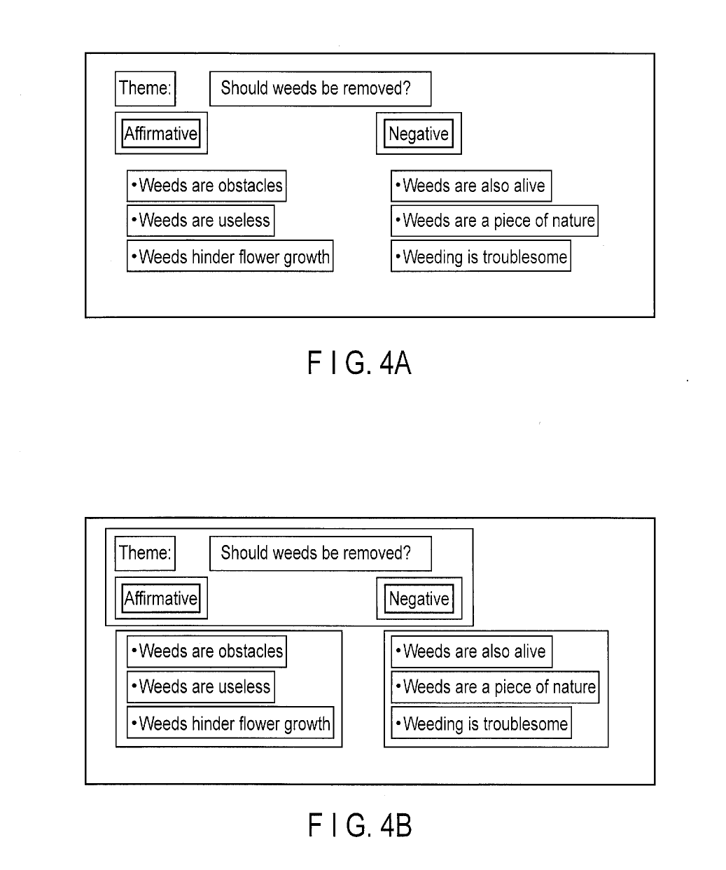

The structuring processor 58 integrates a plurality of writing blocks input from the background/writing block extraction module 54 into a writing area in consideration of the unity of time and space, and outputs the writing area to the end computation module 56. FIGS. 4A and 4B show an example of the operation of the structuring processor 58. As shown in FIG. 4A, a plurality of writing blocks are included in an image of the blackboard. The writing blocks are extracted in units of character, word and line. These writing blocks are integrated into one or more writing areas. A main writing direction of the writing block is one of the bases for integration of the writing blocks. A histogram of the positional relationship between writing blocks temporally adjacent to each other is computed for all the writing blocks included in the images of the blackboard, and a writing direction having a high frequency is determined as the main writing direction. The positional relationship is the rightward direction in horizontal writing and the downward direction in vertical writing. If the positional relationship between writing blocks temporally adjacent to each other is the same as the main writing direction, these writing blocks are integrated. Furthermore, a writing block having a writing direction different from the main writing direction is determined as a start point of a new line and is also integrated into a writing area. For example, when a line is written and writing of the next line is started, the positional relationship is once changed from the rightward direction to the leftward direction. In the next line, the positional relationship is returned to the rightward direction. By the above process, the writing blocks on the blackboard can be integrated into one or more writing areas that are significant units as shown in (b) in FIG. 4B.

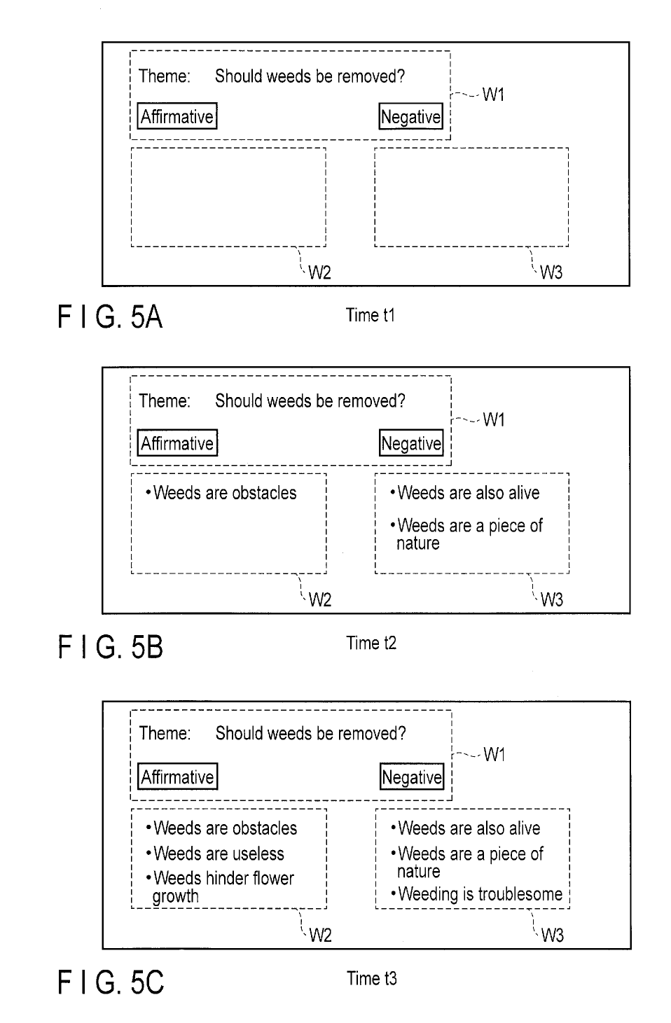

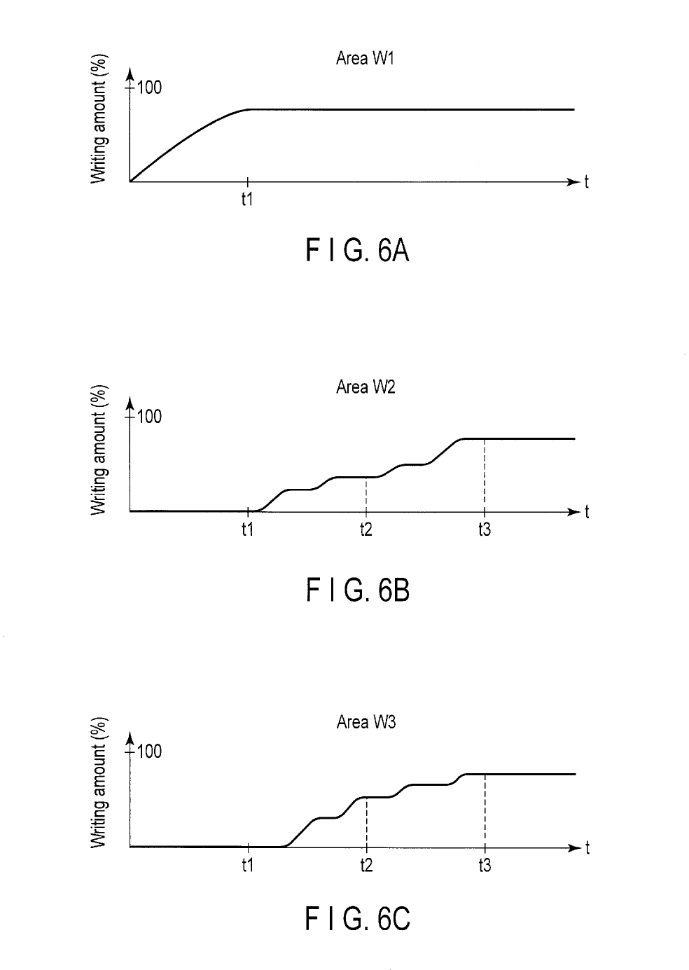

The end computation module 56 computes a writing amount by using the background and the writing blocks input from the background/writing block extraction module 54 and/or the writing areas input from the structuring processor 58, and computes a timing when the writing amount reaches a maximum value or a predetermined value or a timing when the writing amount is substantially saturated (i.e., when the change rate of the writing amount becomes lower than a threshold value), as an end timing showing that writing of a topic is temporarily stopped. FIGS. 5A, 5B and 5C show a temporal change of the blackboard. FIGS. 6A, 6B and 6C show an example of a temporal change of the writing amounts on the blackboard in FIG. 5C. The writing amounts shown in FIGS. 6A, 6B and 6C are each computed as a ratio of writing blocks to a writing area.

FIGS. 5A, 5B and 5C show states of the blackboard at times t1, t2 and t3, respectively. At time t1, writing of a theme in a writing area W1 is completed. At time t2, writing of arguments for the theme in a writing area W2 and writing of arguments against the theme in a writing area W3 are not completed. At time t3, the writing is completed in both areas W2 and W3. It is assumed that the writing in area W3 has a speed higher than that of the writing in area W2 and is completed before the completion of the writing in area W2. At times t1 and t2, when the writing is not completed, the structuring processing is not completed either and writing areas W1, W2 and W3 are not detected. The writing blocks are subjected to the structuring processing and integrated into the three writing areas W1, W2 and W3 at time t3 when almost all the writing blocks are written. Since which writing area includes each writing block is determined at time t3, the temporal change of the writing amount in each writing area can be seen from time t3 as shown in FIGS. 6A, 6B and 6C.

The writing of the theme area W1 is completed before the writing of the affirmative area W2 and the negative area W3. Upon the finding of new arguments, writing blocks are added to the affirmative area W2 and the negative area W3. In this example, the contents once written in the three writing areas W1, W2 and W3 are not erased except for an error. Therefore, the writing amount being almost unchanged can be a predetermined condition to compute an end timing. Thus, as shown in FIGS. 6A, 6B and 6C, a computation shows that an end timing of writing area W1 is time t1 and end timings of writing areas W2 and W3 are time t3. However, the condition for computation is not limited to this. For example, the condition for computation may be at least one of the writing amount exceeding a predetermined value (for example, 80%) and the writing amount reaching a maximum value.

As described above, on the basis of a writing amount computed from a ratio between a background and writing blocks extracted from a moving image and/or a ratio between writing blocks extracted from the moving image and a writing area that is a set of these writing blocks, the temporary stop of writing in the writing blocks and/or the writing areas can be computed. Therefore, start/end points of topics can be detected in images showing a writing process in which contents are momentarily changed, and the images can be divided into a plurality of chapters according to the topics. By sequentially reproducing the start points of the chapters, the end point of a topic alone can be efficiently viewed, the whole of the time-series images can be understood for a short time, and images of a desired topic can be immediately found.

In addition, when extracting the writing blocks, the writing blocks can be distinguished from the occlusion block depending on whether the positions of areas having pixel values different from that of the background temporally change or not. Therefore, the correct writing amount can be computed.

### EXAMPLE 2

### Example of Adding Chapter Image Generation Module 60 and LCD 42 to Configuration of Example 1

Example 2 aims to facilitate selection of a chapter to be reproduced in a moving image of a lecture using a blackboard by extracting writing blocks and writing areas, computing, based on the extracted writing blocks and writing areas, end timings showing that writing on a topic is temporarily stopped, dividing the moving image into chapters according to the end timings, and displaying chapter images representative of the respective chapters. Example 2 is the same as Example 1 except that the chapter images are generated in the chapter image generation module 60, a screen to select a chapter is displayed on the LCD 42, and the reproduction is started from a timing corresponding to the selected chapter image. Therefore, the differences from Example 1 are described in detail.

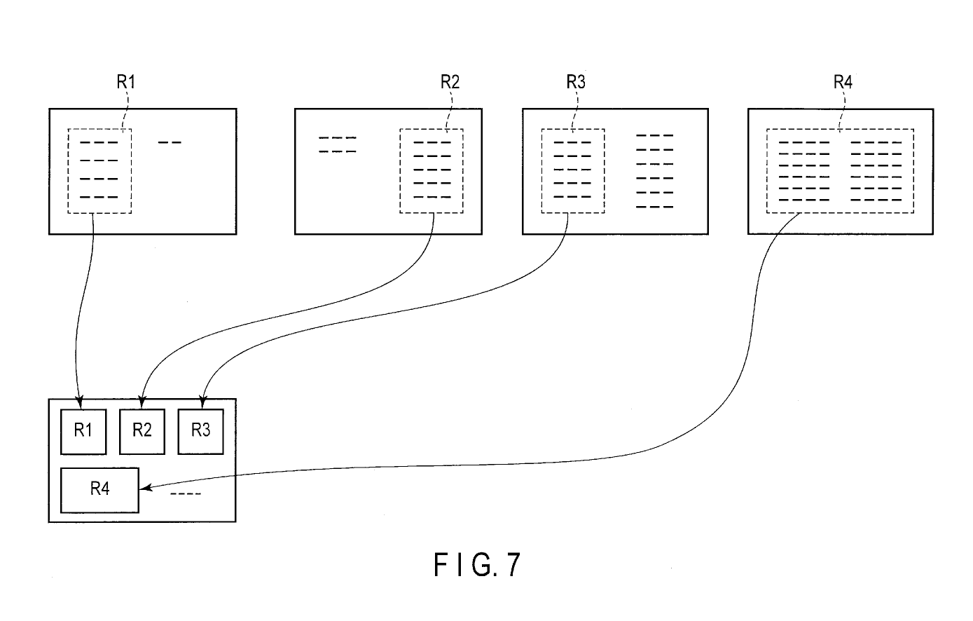

FIG. 7 shows an example of chapter images generated by the chapter image generation module 60. Since a time when writing is temporarily stopped is computed as an end timing in the end computation module 56, generating an image at the computed end timing as a chapter image (image at the end point of a chapter) is the simplest operation. In Example 2, the writing amount is computed by a ratio of writing blocks to a writing area. Four images in the upper half of FIG. 7 are chapter images at four end timings. Starting from the left, the four chapter images correspond to an end timing of writing in a left half area R1, an end timing of writing in a right half area R2, an end timing of writing in a left half area R3 performed after the writing in area R1 is erased, and an end timing of writing in a whole area R4 of the blackboard including area R3 and a right half area where writing is performed after the writing in area R2 is erased, respectively. If these images are shown as chapter images without any change, there is a large amount of wasted space in a display area considering that the images may be viewed by means of a device having a small display screen such as a mobile device. To solve the problem, a combined chapter image is generated by extracting images of areas R1, R2, R3 and R4 alone related to the computation of the end timings from the four chapter images shown in the upper half of FIG. 7 and combining the extracted images to fit into a screen size of a visual display device. Since the combined chapter image excludes areas in the images at the end timings unrelated to the computation of the end timings, the screen of the device can be used efficiently. If a large number of end timings are computed (i.e., a large number of chapter images are generated), a plurality of combined chapter images may be generated by combining several of the chapter images instead of combining the large number of chapter images into a single combined chapter image.

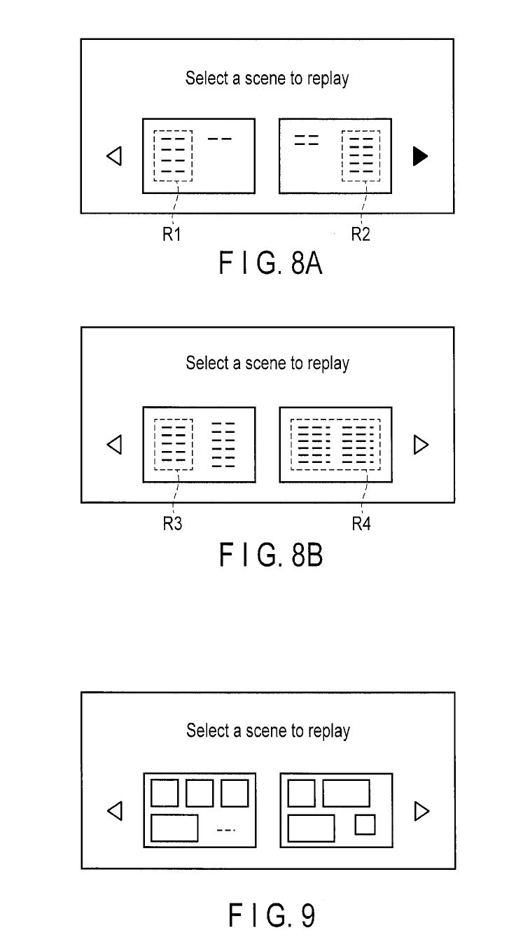

FIGS. 8A and 8B show an example of a list of the chapter images displayed on the LCD 42. In FIGS. 8A and 8B, the four chapter images shown in the upper half of FIG. 7 are displayed two by two. If a triangle icon on the right or left side is selected, two displayed chapter images are switched at the same time.

FIG. 9 shows another example of a list of the chapter images displayed on the LCD 42. In FIG. 9, the combined chapter image shown in the lower half of FIG. 7 is displayed two by two. If a triangle icon on the right or left side is selected, two displayed combined chapter images are switched at the same time.

In the list display shown in FIGS. 8A and 8B and FIG. 9, if any one of the chapter images (any one area in the chapter images in the case of FIG. 9) is selected, time-series images can be reproduced from an end timing corresponding to the selected chapter image (selected area). However, the end timing is also a start point of the next topic. If the reproduction is started from the end timing, the topic is immediately switched to the next topic and the topic including the selected end timing cannot be viewed. Therefore, the time-series images may be reproduced from an end timing immediately preceding the end timing corresponding to the selected chapter image. The chapter relate to a desired topic can be thereby checked from the beginning.

As described above, a chapter that the user is interested in and desires to view can be immediately reproduced by computing sets of writing blocks extracted from a moving image (i.e., writing areas), computing a timing when writing is temporarily stopped as an end timing, showing the user a list of chapter images representative of chapters obtained by dividing the moving image according to the end timings, and allowing the user to select a chapter image. Therefore, the desired chapter alone can be efficiently viewed without reproducing all the time-series images. Since the end timing is computed by using a writing amount computed from a ratio of writing blocks to a writing area, the images include areas unrelated to the computation of the end timings. In this example, the areas unrelated to the computation of the end timings are excluded when a combined chapter image is generated by combining images related to the end timings. Therefore, when a list of chapter images is displayed for selection of the beginning of a chapter, only the areas that were actually used for the end computation are combined and displayed. The list of chapter images can be thereby efficiently displayed even on a device having a small screen.

### Example 3

### Highlighting

In Example 3, only a writing area corresponding to an end timing is highlighted in blackboard contents of a lecture. Example 3 is different from Example 2 in that the writing area related to the computation of the end timing is highlighted when a chapter image corresponding to the end timing is generated by the chapter image generation module 60. Therefore, the chapter image generation module 60 alone is hereinafter described in detail.

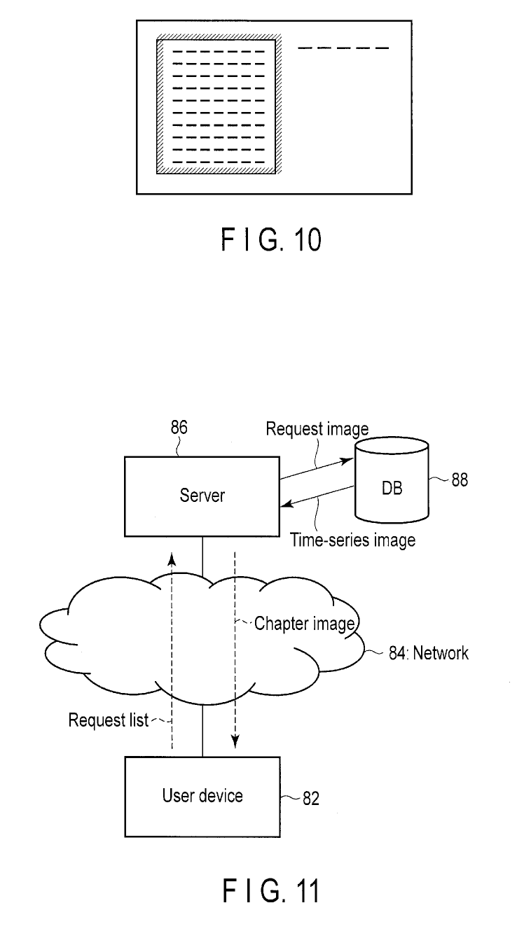

FIG. 10 shows an example of a chapter image generated by the chapter image generation module 60. Since a time when writing of a certain area is temporarily stopped is computed as an end timing in the end computation module 56, generating an image at the computed end timing as a chapter image is the simplest operation. However, the writer often consciously divides the whole area of the blackboard into a plurality of areas and repeats writing and erasing per area. Therefore, by simply generating an image at the computed end timing as a chapter image, the generated image also includes an area where writing has already stopped and an area where writing is still continued. If this image is displayed as a chapter image, an area where writing is stopped just at the end timing is hardly found due to the previously written contents left in the image. To solve the problem, an image where only a writing area corresponding to the end timing is highlighted is displayed as a chapter image. The significant contents can be thereby checked from the chapter image. In the example of FIG. 10, an area R1, R2, R3 or R4 related to the computation of the end timings in the images at the end timings shown in the upper half of FIG. 7 is highlighted. The contents of writing stopped at the end timing can be thereby understood without the combining processing shown in FIG. 7.

### Modified Example

In the above embodiment, the general-purpose computer executes all the processing. However, as shown in FIG. 11, the processing may be partly executed in another device, for example, in a server on a network. A user device 82 is connected to a server 86 via a network 84 such as the Internet. A database 88 storing a large number of educational materials is connected to the server 86. The user device 82 has the same system configuration as the configuration shown in FIG. 1 except that the automatic chaptering application program is installed not in the user device 82 but on the side of the server 86.

The user device 82 requests a list of images of an educational material from the server 86 via the network 84. The server 86 requests images of the educational material from the database 88 and receives the images from the database 88. The server 86 executes the automatic chaptering application program and executes the processing shown in FIG. 2 for the images received from the database 88. The educational material is thereby divided into chapters and chapter images can be acquired. The server 86 transmits the chapter images to the user device 82, causes the user device 82 to display the chapter images as shown in FIGS. 8A and 8B, FIG. 9 and FIG. 10 and allows the user to select a chapter image. The educational material is reproduced from a timing corresponding to the selected chapter image.

The same effect and advantage as the embodiment can also be achieved by such a structure.

In the example of FIG. 11, image data of the educational material is stored on the side of the server 86. However, the image data may be stored in the user device 82. In this case, the image data may be uploaded to the server 86 and then divided into chapters on the side of the server 86, and chapter images acquired as a result of the division may be downloaded to the user device 82.

The procedures described in the above embodiment can be executed by a program that is software. If a general-purpose computer system storing the program reads the program, the same advantage as the image processor of the above embodiment can be achieved. The procedures described in the above embodiment are stored as a program that can be executed by a computer in a storage medium such as a magnetic disk (flexible disk, hard disk, etc.), an optical disk (CD-ROM, CD-R, CD-RW, DVD-ROM, DVD±R, DVD±RW, etc.), a semiconductor memory or the like. A format of the data storage may be any format if the storage medium is readable by a computer or an embedded system. If the computer reads a program from the storage medium and causes the CPU to carry out instructions described in the program based on the program, the same operation as the image processor of the embodiment can be implemented. Of course, the computer may acquire or read the program via the network.

In addition, each procedure to implement the present embodiment may be partly executed by the operating system (OS), middleware such as database management software and a network, etc., that operate based on instructions of the program installed from the storage medium to the computer or the embedded system.

Furthermore, the storage medium of the present embodiment is not necessarily independent of the computer or the embedded system. The storage medium also includes a storage medium that downloads and stores or temporarily stores a program transmitted via the LAN, the Internet, etc.

Moreover, the processing of the present embodiment is not necessarily executed by means of a single storage medium, but may be executed by means of a plurality of storage media.

The computer or the embedded system of the present embodiment executes each procedure in the present embodiment based on the program stored in the storage medium, and may be a device such as a personal computer of a microcomputer constituted by one device, a system constituted by a plurality of network-connected devices or the like.

The computer of the present embodiment is not limited to a personal computer, but includes an arithmetic processing unit, a microcomputer, etc., included in an information processing device, and is a generic name for a device that can implement the functions of the present embodiment by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processor comprising:
a writing amount detector configured to detect a writing amount in an image; and
an end timing detector configured to detect an end timing of writing based on the writing amount detected by the writing amount detector.

2. The image processor of claim 1, further comprising:
a reproduction module configured to reproduce the image in accordance with chapters obtained by dividing the image at the end timing.

3. The image processor of claim 1, further comprising:
a display configured to display chapter images indicative of chapters obtained by dividing the image at the end timing; and
a reproduction module configured to reproduce, in response to selection of any one of the chapter images displayed by the display, the image from an end timing corresponding to the selected chapter image or an end timing corresponding to a preceding chapter image.

4. The image processor of claim 3, wherein
the display is configured to display an image corresponding to the end timing as the chapter image.

5. The image processor of claim 3, wherein
the display is configured to extract images of portions in which writing is temporarily stopped from images corresponding to end timings, combine the extracted images into a single chapter image and display the single chapter image.

6. The image processor of claim 3, wherein
the display is configured to display the chapter image while highlighting an image of portion in which writing is temporarily stopped.

7. The image processor of claim 1, wherein
the writing amount detector is configured to extract a background and writing blocks from the image and detect a ratio of the writing blocks to the background as the writing amount.

8. The image processor of claim 7, wherein
the writing amount detector is configured to detect an area constant in color in the image as the background.

9. The image processor of claim 7, wherein
the writing amount detector is configured to detect a portion which is different from the background and whose position is unchanged regardless of elapsed time as the writing block.

10. The image processor of claim 7, wherein
the end timing detector is configured to detect a timing when the writing amount is a maximum as the end timing.

11. The image processor of claim 7, wherein
the end timing detector is configured to detect a timing when the writing amount reaches a predetermined value as the end timing.

12. The image processor of claim 7, wherein
the end timing detector is configured to detect a timing when a change rate of the writing amount becomes lower than a first value as the end timing.

13. The image processor of claim 1, wherein
the writing amount detector is configured to extract writing blocks from the image and detect a ratio of some writing blocks to a writing area obtained by integrating the some writing blocks as the writing amount.

14. The image processor of claim 13, wherein
the writing amount detector is configured to integrate the writing blocks into the writing area based on a writing direction.

15. A method comprising:
detecting a writing amount in an image;
detecting an end timing of writing based on the detected writing amount;
dividing the image into chapter images based on the detected end timing of writing; and
displaying the chapter images.

16. A non-transitory computer-readable storage medium having stored thereon a computer program which is executable by a computer, the computer program comprising instructions capable of causing the computer to execute functions of:
detecting a writing amount in an image;
detecting an end timing of writing based on the detected writing amount;
dividing the image into chapter images based on the detected end timing of writing; and
displaying the chapter images.
